(19) United States
(12) Patent Application Publication
(10) Pub. No.: US 2025/0190518 A1
(43) Pub. Date: Jun. 12, 2025

(54) GROUPED CONVOLUTION PROCESSING OPTIMIZATION DEVICE AND GROUPED CONVOLUTION PROCESSING OPTIMIZATION METHOD

(71) Applicant: NEC Corporation, Tokyo (JP)

(72) Inventor: Seiya SHIBATA, Tokyo (JP)

(73) Assignee: NEC Corporation, Tokyo (JP)

(21) Appl. No.: 18/945,659

(22) Filed: Nov. 13, 2024

(30) Foreign Application Priority Data
Dec. 6, 2023 (JP) 2023-206216

(51) Int. Cl. G06F 17/15; G06F 17/16

(52) U.S. Cl. CPC G06F 17/153; G06F 17/16

(57) ABSTRACT

The device includes a first unit that executes at least one of a column process that inserts (M−N/G) columns of zeros at the right end of an i-th weight for each i from 1 to G or a row process that inserts (M−N/G) rows of zeros at the bottom of the i-th weight for each i from 1 to G, when a constraint that requires convolution computation to be executed on data composed of M channels for a grouped convolution is imposed and a second unit that executes at least one of an input weight process that inserts (M−N/G) columns of zeros to the right of the i×N/G-th column of the input weight for each i from 1 to G or an output weight process that inserts (M−N/G) rows of zeros below the i×N/G-th row of the output weight for each i from 1 to G.

This application is based upon and claims the benefit of priority from the prior Japanese Patent Application No. 2023-206216, filed Dec. 6, 2023, the entire contents of which are incorporated herein by reference.

### BACKGROUND OF INVENTION

### Field of the Invention

This disclosure relates to a grouped convolution processing optimization device, a grouped convolution processing optimization method, and a grouped convolution processing optimization program.

### Description of the Related Art

A convolutional neural network (CNN) is a feedforward neural network that has a structure where two types of layers, convolutional layers and pooling layers, are alternately stacked. Hereinafter, the convolutional neural network will be referred to simply as CNN.

FIG. 12 is an explanatory diagram illustrating an example of a convolutional neural network. In the CNN shown in FIG. 12, a first convolutional layer, a first pooling layer, a second convolutional layer, and a second pooling layer are alternately stacked.

In addition, C₁ and C₂ shown in FIG. 12 represent convolutional computations. For example, convolutional computation C₁ is executed for the input image input to the first convolutional layer.

Note that an image is merely an example of the data being input. The data input to the CNN may be data other than images.

Furthermore, P₁ and P₂ shown in FIG. 12 represent pooling computations. For example, pooling computation P₁ is executed for the result of the convolutional computation input to the first pooling layer.

In addition, F shown in FIG. 12 represents a fully connected network. The fully connected network F has the functionality of a fully connected layer that connects all nodes of the second pooling layer to all nodes of the output layer. Finally, the output of the CNN is obtained from the output layer.

Hereinafter, convolutional computation in a CNN will be described in detail. FIG. 13 is an explanatory diagram illustrating an example of convolutional computation in a CNN. Note that the example of convolutional computation shown in FIG. 13 corresponds to the convolutional computation C₁ shown in FIG. 12.

The input image shown in FIG. 13 is an image input to the CNN. The input image shown in FIG. 13 is composed of channels from the first channel to the Cᵢₙ-th channel (Cᵢₙ is an integer of 2 or more) arranged in order. In other words, Cᵢₙ indicates the number of input channels. Furthermore, as shown in FIG. 13, the height of the image constituting the input image is H, and the width is W.

For the sake of simplicity, consider an image with a height and width of 1, and the number of channels is Cᵢₙ, as the input X, as shown in the lattice pattern in FIG. 13. The lower part of

FIG. 13 shows the input X as viewed from the vertical direction. The symbols below input X in FIG. 13 indicate the channel identification numbers (the same applies to other figures).

That is, in the example of convolutional computation shown in FIG. 13, the kernel size is “1×1”. However, the following explanation applies to kernel sizes other than “1×1” (for example, “3×3” or “5×5”).

In the convolutional computation shown in FIG. 13, input X is multiplied by a weight W, which is represented by diagonal lines and has a width of Cₒᵤₜ and a height of Cᵢₙ. As a result of this multiplication, an output Y₀, represented by a black rectangle with a channel count of Cₒᵤₜ, is obtained. In other words, Cₒᵤₜ indicates the number of output channels.

Note that the convolutional computation shown in FIG. 13 corresponds to matrix multiplication. That is, in the convolutional computation shown in FIG. 13, the weight W is treated as a matrix, and the input X and output Y₀ are treated as vectors, which are a type of matrix. In this specification, “weight” technically refers to the “weight matrix,” but for simplicity, it is referred to as “weight.”

In this specification, the input X and output Y₀ are consistently expressed as row vectors (vectors with components arranged horizontally), and the weights are expressed as matrices. Furthermore, the convolutional computation is expressed as the product of the input row vector multiplied from the left by the weight matrix.

The terms “row” and “column” used in this specification are based on the above premise. Therefore, when another mathematically equivalent representation is substituted, the terms “row” and “column” shall be interpreted accordingly.

The CNN shown in FIG. 12 and FIG. 13 is a pre-trained model. That is, the weight W shown in FIG. 13 is a weight obtained through pre-executed training.

There is an increasing number of CNNs that use grouped convolution for convolutional computation. In grouped convolution, Cᵢₙ and Cₒᵤₜ are divided into G groups (G is an integer of 2 or more) for computation processing. For example, Non-Patent Literature 1 describes grouped convolution.

The amount of computation in grouped convolution is smaller than that in regular convolution. Furthermore, it has been experimentally shown that the recognition accuracy of ResNet (Residual Neural Networks), which uses grouped convolution, is higher than that of ResNet, which uses regular convolution, which is a type of CNN.

Hereinafter, the computation of grouped convolution in CNNs will be described in detail. FIG. 14 is an explanatory diagram illustrating an example of grouped convolution computation in one grouped convolution layer.

The example of grouped convolution computation shown in FIG. 14 corresponds to a case where grouped convolution is applied instead of the convolution computation shown in FIG. 13. In this example, a case where an AI (Artificial Intelligence) chip executes the grouped convolution computation is considered.

In the example of grouped convolution computation shown in FIG. 14, the number of groups is defined as “8”. That is, the grouped convolution layer used in the example shown in FIG. 14 is a pre-trained layer in which the input X is divided into 8 groups in the channel direction, and convolution computation is executed on each group.

Note that input X, which is an image, is merely an example of input data. The data input to the grouped convolution layer may also be non-image data.

As shown in FIG. 14, the grouped convolution computation uses weights Wₐ to Wₕ, each with a vertical size of (Cᵢₙ/8) and a horizontal size of (Cₒᵤₜ/8). There are various possible methods for implementing an AI chip to execute the grouped convolution computation. In this example, it is assumed that the AI chip performs the following operations.

The AI chip multiplies weight Wₐ by the image composed of channels from the first channel to the (Cᵢₙ/8)-th channel (which has a channel count of (Cᵢₙ/8)). As a result of this multiplication, the AI chip obtains an output image with a channel count of (Cₒᵤₜ/8).

As shown in FIG. 14, the AI chip executes the same computation for weights W_{b} through Wₕ. That is, the AI chip divides input X into 8 parts in the channel direction and executes convolution computation for each image composed of channels {(i−1)×(Cᵢₙ/8)+1} to {i×(Cᵢₙ/8)} (i=1 to 8) using the i-th weight matrix. The first to eighth weight matrices correspond to weights Wₐ to Wₕ, respectively. As a result of these computations, the AI chip obtains 8 output images, each with a channel count of (Cₒᵤₜ/8).

Finally, the AI chip places the obtained images in the same positions as the corresponding divided input X parts. After placing the 8 obtained images, the AI chip concatenates them (indicated as “concat” in FIG. 14).

By concatenating the images, the AI chip obtains output Y, which is an image with a channel count of Cₒᵤₜ, equivalent to the result of regular convolution computation. However, the output Y obtained from the grouped convolution computation shown in FIG. 14 is not equivalent to the output Y₀ obtained from the convolution computation shown in FIG. 13.

The computational cost of convolution is proportional to the size of the weights. For example, the computational cost of the convolution shown in FIG. 13 is proportional to the size (Cᵢₙ×Cₒᵤₜ) of weight W. The computational cost of the grouped convolution shown in FIG. 14 is proportional to the sum of the sizes of weights Wₐ to Wₕ, that is, {(Cᵢₙ/8)×(Cₒᵤₜ/8)×8}. In other words, the computational cost of the grouped convolution shown in FIG. 14 is ⅛ of the computational cost of the convolution shown in FIG. 13.

In general, when input X is divided into G groups for grouped convolution computation, the computational cost of the grouped convolution is proportional to {(Cᵢₙ/G)×(Cₒᵤₜ/G)×G}=(Cᵢₙ×Cₒᵤₜ)/G. That is, the computational cost of the grouped convolution shown in FIG. 14 is 1/G of the computational cost of the convolution shown in FIG. 13.

FIG. 15 is an explanatory diagram illustrating another example of grouped convolution computation in a grouped convolution layer. In FIG. 15, weights Wₐ to Wₕ shown in FIG. 14 are arranged diagonally from the top-left to the bottom-right of the weight W. The values of the elements in areas other than where weights Wₐ to Wₕ are arranged (shown by dashed lines in FIG. 15) may be arbitrary.

As shown in FIG. 15, weight W has a vertical size of Cᵢₙ and a horizontal size of Cₒᵤₜ. In the grouped convolution computation shown in FIG. 15, the AI chip executes the computation by multiplying weight W by input X only once. By executing the computation only once, the AI chip obtains output Y.

For AI chips that are not optimized for grouped convolution, it is possible that the grouped convolution computation will be implemented as multiple separate convolution computations.

Therefore, for AI chips where the convolution computation is implemented multiple times, the AI chip will incur overhead due to the repeated invocation of the convolution computation G times when executing grouped convolution. When the AI chip incurs overhead G times, the computation speed of the grouped convolution decreases.

In the grouped convolution computation shown in FIG. 15, the AI chip incurs the overhead only once, minimizing the impact of overhead. Therefore, the computation speed of the grouped convolution may increase.
[Non-Patent Literature 1] S. Xie, R. Girshick, P. Dollar, Z. Tu, and K. He, “Aggregated residual transformations for deep neural networks,” in Computer Vision and Pattern Recognition, 2017.

### SUMMARY OF INVENTION

The following possibilities may also exist as reasons why the AI chip may not be suitable for grouped convolution. Some AI chips designed for CNNs have strict constraints imposed on the number of rows and columns of weights corresponding to the number of channels, as well as on the memory layout, that is, memory addressing.

The phrase “imposing constraints” means that, while the computation speed can be fully maximized as long as the constraints are followed, when the constraints are not met, the computation speed performance significantly deteriorates. These memory addressing constraints are imposed to reduce the complexity of the AI chip's memory access circuitry.

For example, the addressing of arrays in multiples of certain constants may be a constraint on memory addressing. In a 32-bit memory address, when the head address of an array is placed at a multiple of 16, ignoring the lower 4 bits, access to the array is possible without the need for circuitry to handle the lower 4 bits.

When a constraint is imposed on the starting address of weights used in grouped convolution, the constraint effectively applies to the starting address of Cᵢₙ*Cₒᵤₜ or Cᵢₙ*Cₒᵤₜ* (kernel size) for each group, since convolution operations are executed for each group. FIG. 16 is an explanatory diagram illustrating an example of weights used in grouped convolution placed in memory.

As shown in FIG. 16, the weights used in grouped convolution are generally stored in memory as a contiguous block of data. The size of each weight shown in FIG. 16 is ((Cᵢₙ/8)*(Cₒᵤₜ/8)). Since there are 8 groups, the total weight size is ((Cᵢₙ/8)*(Cₒᵤₜ/8))*8.Software, such as a compiler, that determines the memory placement of the weights takes into account the constraints imposed on the AI chip and places the weights in memory so that the starting address of the weights, with a size of ((Cin/8)*(Cout/8))*8, meets those constraints.

However, in grouped convolution, as shown in FIG. 14, the inputs and weights may be divided. In this case, the starting address of each divided weight unit must also meet the constraint. For example, the size of each weight shown in FIG. 16 is ((Cᵢₙ/8)*(Cₒᵤₜ/8)). Therefore, the starting addresses for each weight when accessed one at a time must meet the constraints for 0*((Cᵢₙ/8)*(Cₒᵤₜ/8)), 1*((Cᵢₙ/8)*(Cₒᵤₜ/8)), and so on, so the starting address of each of the 8 groups must meet the constraint.

However, depending on the value of ((Cᵢₙ/8)*(Cₒᵤₜ/8)) for each group, not all starting addresses may meet the constraint.

In some cases, the AI chip may fail to operate correctly when the constraints are not met. In such cases, additional processes may be required to adjust the placement of weights in memory to meet the constraints. When additional processes to adjust memory placement are added, the overall processing by the AI chip may slow down.

For example, in the case of grouped convolution shown in FIG. 14, where Cᵢₙ=160 and G=16, the number of channels for the divided input X becomes Cᵢₙ/G=10. That is, in an AI chip designed with a constraint that Cᵢₙ should be a multiple of 16, the constraint that Cᵢₙ is a multiple of 16 is not met. Furthermore, the starting addresses of weights other than weight Wₐ are not multiples of 16.

Therefore, to meet the constraint, it may be necessary to perform memory address adjustments, such as memory copying the input X and weight Wₐ before each convolution execution, to align the starting memory addresses. The overhead incurred by memory copying is likely to cause a slowdown in the grouped convolution speed.

Additionally, AI chips designed specifically for convolution may lack circuits dedicated to memory copying. In such cases, memory copying may be performed by a host CPU (Central Processing Unit) or an auxiliary CPU, which can handle flexible processing but may operate at a slower speed. When memory copying is handled by the host CPU or an auxiliary CPU, the grouped convolution speed may further decrease.

Zero-padding may be considered as a method to meet the constraints. However, zero-padding must be inserted between the divided units of input X rather than simply at the end of input X. Therefore, even when zero-padding is applied in grouped convolution, the overhead incurred by memory copying remains significant.

FIG. 17 is an explanatory diagram illustrating an example of zero-padding applied to input X for grouped convolution. FIG. 17 shows an example where Cᵢₙ=160 and G=8 for grouped convolution, and the starting address of each divided unit of input X must be aligned to a multiple of 16.

As shown in the upper part of FIG. 17, Cᵢₙ/G=20. Thus, the starting address of each divided unit of input X is a multiple of 20, which is not a multiple of 16.

Among the multiples of 16, the smallest multiple greater than or equal to 20 is 32. Therefore, it is considered that zero-padding should be applied such that the starting address of each divided unit of input X becomes a multiple of 32 (hereinafter referred to as “32-aligned state”).

As shown in the lower part of FIG. 17, by inserting zero-padding between the divided units of input X, the 32-aligned state is achieved. The white rectangles shown in FIG. 17 represent regions where the values of the elements are zero. Additionally, the number of input channels changes to Cᵢₙ′=256.

However, when zero-padding is applied before each grouped convolution execution, multiple memory copy operations will also be added to the design. The added memory copy operations involve, for example, securing a new memory area for Cᵢₙ′=256 and copying each divided unit of input X to an address that is a multiple of 32. Since this process is relatively computationally intensive, the memory copying is likely to become a cause of grouped convolution slowdown.

The technology to address the problem of reduced execution speed in grouped convolution due to hardware circuits with memory addressing constraints is not described in Non-Patent Literature 1.

Therefore, the purpose of the present disclosure is to provide a grouped convolution processing optimization device, a grouped convolution processing optimization method, and a grouped convolution processing optimization program that enable grouped convolution to be executed at high speed by hardware circuits with memory addressing constraints.

A grouped convolution processing optimization device according to the present disclosure includes a first insertion unit that executes at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined, and a second insertion unit that executes at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G, wherein the second insertion unit executes the input weight matrix insertion process when the row insertion process is executed, and executes the output weight matrix insertion process when the column insertion process is executed.

A grouped convolution processing optimization method according to the present disclosure includes executing at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined, and executing at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G, wherein the input weight matrix insertion process is executed when the row insertion process is executed, and the output weight matrix insertion process is executed, when the column insertion process is executed.

A grouped convolution processing optimization program according to the present disclosure causes a computer to execute a first insertion process that executes at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined, and a second insertion process that executes at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G, wherein the second insertion process causes the input weight matrix insertion process to be executed when the row insertion process is executed, and causes the output weight matrix insertion process to be executed when the column insertion process is executed.

According to the present disclosure, hardware circuits with memory addressing constraints can execute grouped convolution at high speed.

### BRIEF DESCRIPTION OF THE DRAWINGS

FIG. 1 It is a block diagram illustrating a configuration example of a grouped convolution processing optimization device according to the present disclosure.

FIG. 2 It is an explanatory diagram illustrating an example of convolution processing in ResNeXt, as described in Non-Patent Literature 1.

FIG. 3 It is an explanatory diagram illustrating an example where grouped convolution and convolutions before and after the grouped convolution are executed as a set.

FIG. 4 It is an explanatory diagram illustrating another example where grouped convolution and convolution before and after the grouped convolution are executed as a set.

FIG. 5 It is an explanatory diagram illustrating another example where grouped convolution and convolution before and after the grouped convolution are executed as a set.

FIG. 6 It is a flowchart illustrating an operation of a grouped convolution processing optimization device 100 according to the present disclosure.

FIG. 7 It is a flowchart illustrating an operation of a grouped convolution optimization processing executed by the grouped convolution processing optimization device 100 according to the present disclosure.

FIG. 8 It is an explanatory diagram illustrating an example where grouped convolution and convolution before grouped convolution are executed as a set.

FIG. 9 It is an explanatory diagram illustrating an example where grouped convolution and convolution after grouped convolution are executed as a set.

FIG. 10 It is an explanatory diagram illustrating an example of the hardware configuration of the grouped convolution processing optimization device 100 according to the present disclosure.

FIG. 11 It is a block diagram illustrating an overview of a grouped convolution processing optimization device according to the present disclosure.

FIG. 12 It is an explanatory diagram illustrating an example of a convolutional neural network.

FIG. 13 It is an explanatory diagram illustrating an example of convolution computation in CNN.

FIG. 14 It is an explanatory diagram illustrating an example of grouped convolution computation in a grouped convolution layer.

FIG. 15 It is an explanatory diagram illustrating another example of grouped convolution computation in a grouped convolution layer.

FIG. 16 It is an explanatory diagram illustrating an example of how weights used in grouped convolution are placed in memory.

FIG. 17 It is an explanatory diagram illustrating an example of zero-padding applied to input X in grouped convolution.

### DESCRIPTION OF THE PREFERRED EMBODIMENTS

### Explanation of the Configuration

Hereinafter, example embodiments of the present disclosure will be described with reference to the drawings. In the present disclosure, the drawings are associated with one or more example embodiments.

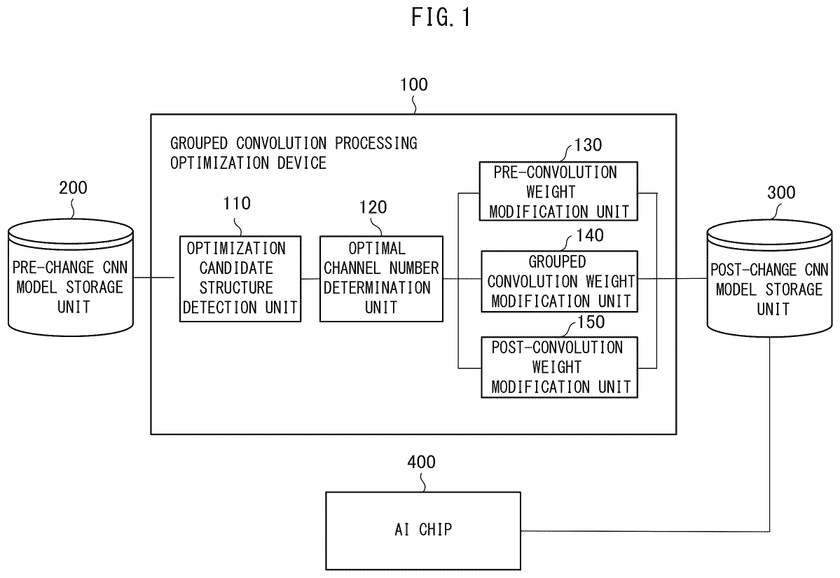

FIG. 1 is a block diagram illustrating a configuration example of a grouped convolution processing optimization device according to the present disclosure. A grouped convolution processing optimization device 100 shown in FIG. 1 is communicatively connected to a pre-change CNN model storage unit 200 and a post-change CNN model storage unit 300.

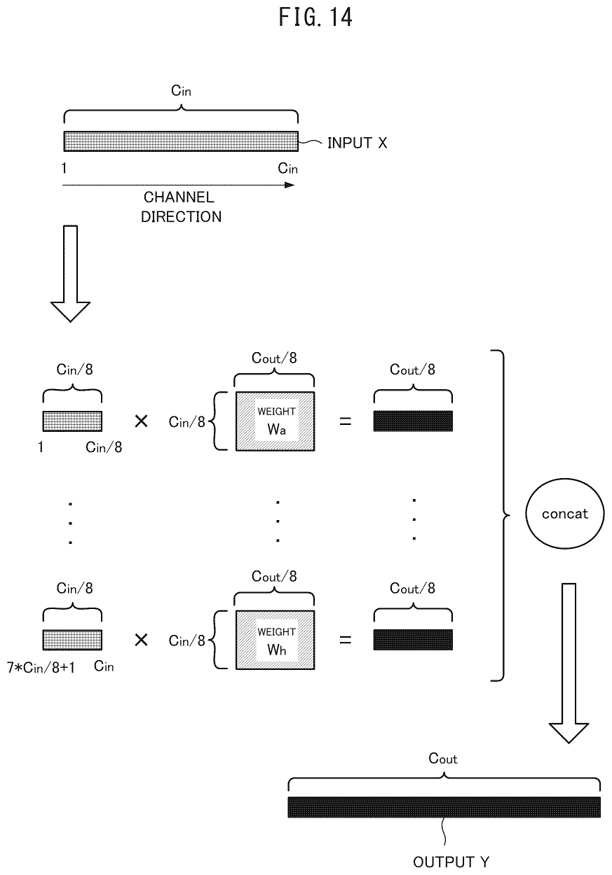

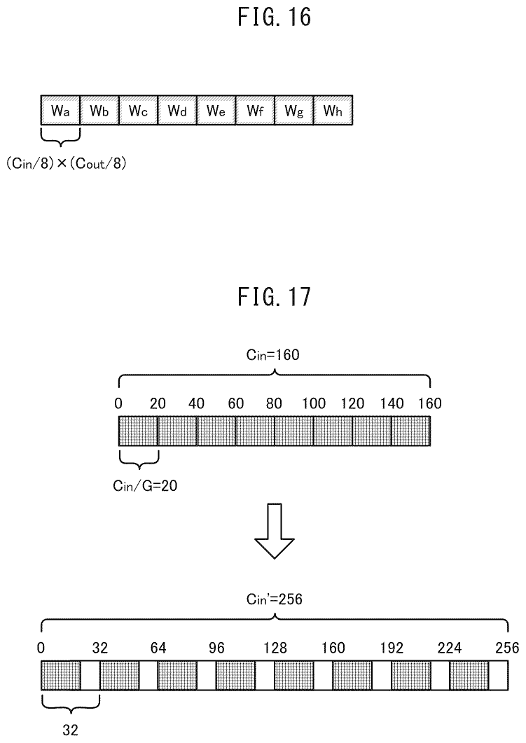

The pre-change CNN model storage unit 200 stores a trained CNN model described above, which includes weights Wₐ to Wₕ as shown in FIGS. 14 to 16. The trained CNN model stored in the pre-change CNN model storage unit 200 is a model that has been trained with grouped convolution defined.

The post-change CNN model storage unit 300 stores the trained CNN model, optimized by the grouped convolution processing optimization device 100, which is stored in the pre-change CNN model storage unit 200.

Additionally, an AI chip 400 is communicatively connected to the post-change CNN model storage unit 300. The AI chip 400 is a chip that executes convolution computations using the trained CNN model stored in the post-change CNN model storage unit 300.

As shown in FIG. 1, the grouped convolution processing optimization device 100 comprises an optimization candidate structure detection unit 110, an optimal channel number determination unit 120, a pre-convolution weight modification unit 130, a grouped convolution weight modification unit 140, and a post-convolution weight modification unit 150.

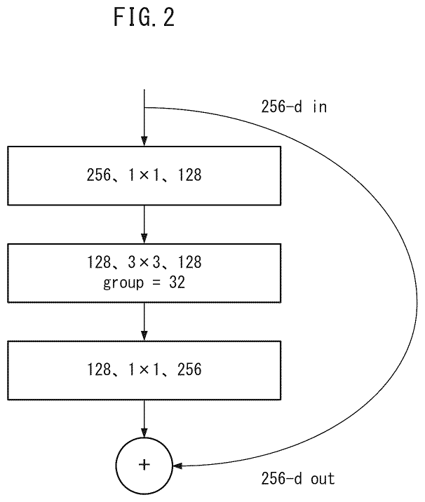

The grouped convolution processing optimization device 100 in this example embodiment assumes that grouped convolution is not used independently, but that other convolution processes exist before and after the grouped convolution. FIG. 2 is an explanatory diagram illustrating an example of convolution processing in ResNeXt, as described in Non-Patent Literature 1.

As shown in FIG. 2, ResNeXt, a representative learning model that uses grouped convolution, utilizes a convolution process with a 1×1 kernel, a grouped convolution with a G=32 group and a 3×3 kernel, and another convolution with a 1×1 kernel. In other words, in ResNeXt, a 1×1 kernel convolution always exists before and after the grouped convolution.

The grouped convolution processing optimization device 100 in this example embodiment is characterized by realizing the 32-aligned state shown in the lower part of FIG. 17 without explicitly performing memory copying. Specifically, the grouped convolution processing optimization device 100 adjusts the input to the grouped convolution to be in the 32-aligned state, as shown at the bottom of FIG. 17, by modifying the convolution calculations performed before and after the grouped convolution.

Additionally, the grouped convolution processing optimization device 100 converts weights used in grouped convolution based on the assumption that the input to the grouped convolution is in the 32-aligned state, as shown in the lower part of FIG. 17.

It should be noted that even when the grouped convolution processing optimization device 100 adjusts the weights, the result of the grouped convolution computation does not change. That is, the grouped convolution processing optimization device 100 achieves faster grouped convolution by adjusting the weights without adding new processes.

The optimization candidate structure detection unit 110 has a function of detecting optimizable grouped convolutions from grouped convolutions present in the structure of the trained CNN model stored in the pre-change CNN model storage unit 200.

The optimization candidate structure detection unit 110 in this example embodiment is characterized by considering grouped convolution optimization as a set with the convolutions that exist before and after the grouped convolution.

The optimal channel number determination unit 120 has a function of determining the number of new input channels and the number of new output channels for a detected grouped convolution in an optimized CNN model.

The pre-convolution weight modification unit 130 has a function of modifying the weights used in a convolution that exists before the detected grouped convolution.

The grouped convolution weight modification unit 140 has a function of modifying each weight used in the detected grouped convolution.

The post-convolution weight modification unit 150 has a function of modifying the weights used in a convolution that exists after the detected grouped convolution.

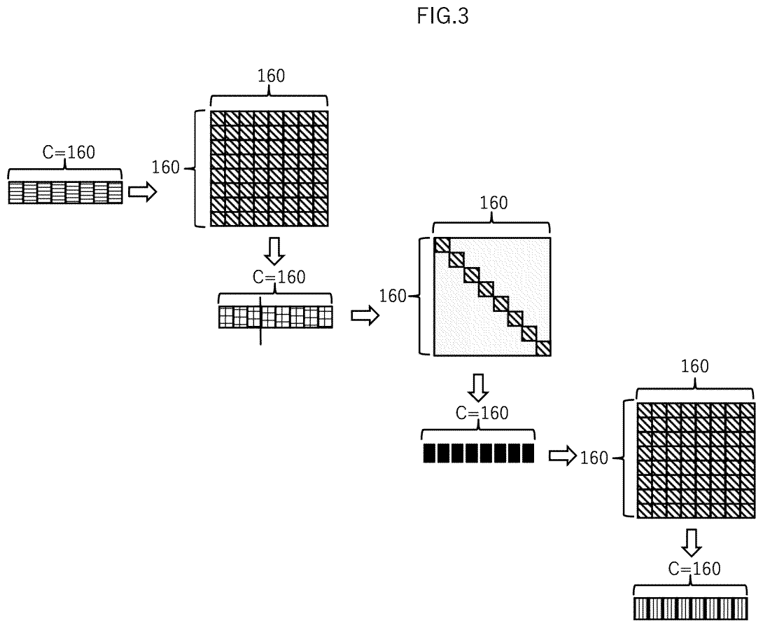

First, an example will be explained in which grouped convolution and convolutions before and after the grouped convolution are executed as a set. FIG. 3 is an explanatory diagram illustrating an example where grouped convolution and convolutions before and after the grouped convolution are executed as a set.

As shown in FIG. 3, first, convolution using a weight of 160 rows and 160 columns is executed on data with C=160, represented by horizontal stripes. Here, C represents the number of channels (the same applies to other figures).

Next, as shown in FIG. 3, grouped convolution is executed on data with C=160 represented by a grid pattern. In the example shown in FIG. 3, G=8. Thus, each convolution is executed individually for each set of data consisting of 160/8=20 channels, which make up the grid-patterned data with C=160, using a weight of 20 rows and 20 columns for each convolution.

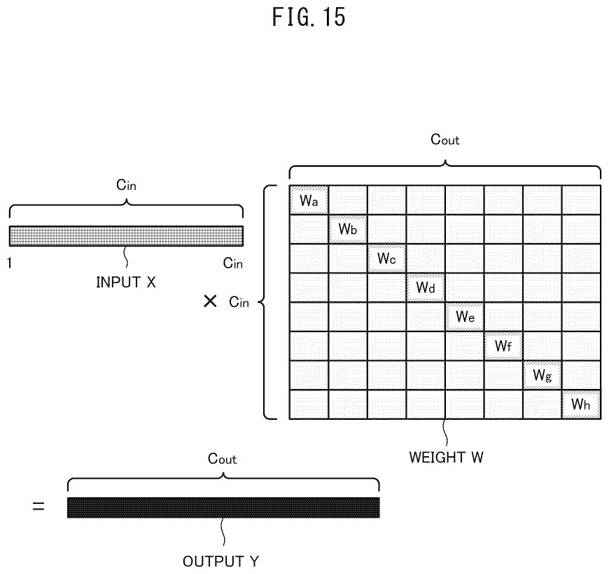

For convenience, the example in FIG. 3 shows how each weight used in the grouped convolution is arranged, as in the example in FIG. 15. However, the method of arranging each weight is not limited to the example shown in FIG. 15.

Next, as shown in FIG. 3, convolution using the weight of 160 rows and 160 columns is executed on data with C=160, represented by black rectangles. As a result of this convolution, data with C=160, represented by vertical stripes, is output.

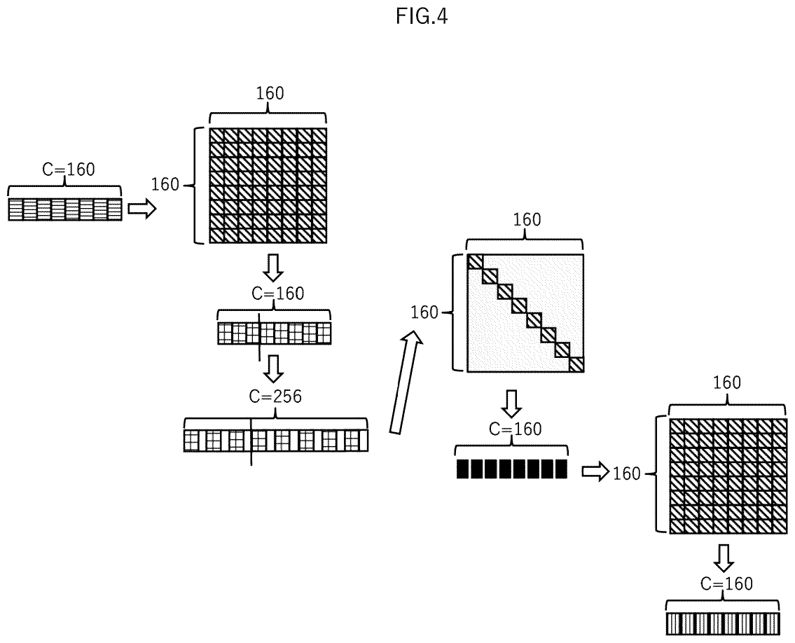

The memory address indicated by the straight lines in the grid-patterned data with C=160 shown in FIG. 3 is 3*20=60. In other words, the starting address of each divided unit of the grid-patterned data is not a multiple of 16. FIG. 4 shows an example where the grid-patterned data is converted so that the starting address of each unit is a multiple of 16.

FIG. 4 is an explanatory diagram illustrating another example where grouped convolution and convolutions before and after the grouped convolution are executed as a set. As shown in FIG. 4, the 32-aligned state is achieved by performing the zero-padding shown in the lower part of FIG. 17 on the grid-patterned data with C=160.

Specifically, the memory address indicated by the straight lines in the grid-patterned data with C=256, shown in FIG. 4, is 3*32=96. That is, the starting address of each divided unit of the grid-patterned data is a multiple of 16. However, as mentioned above, the processing load for converting the grid-patterned data, as shown in FIG. 4, is high.

Note that the grouped convolution and convolution after the grouped convolution shown in FIG. 4 do not reflect any changes due to the conversion of the grid-patterned data.

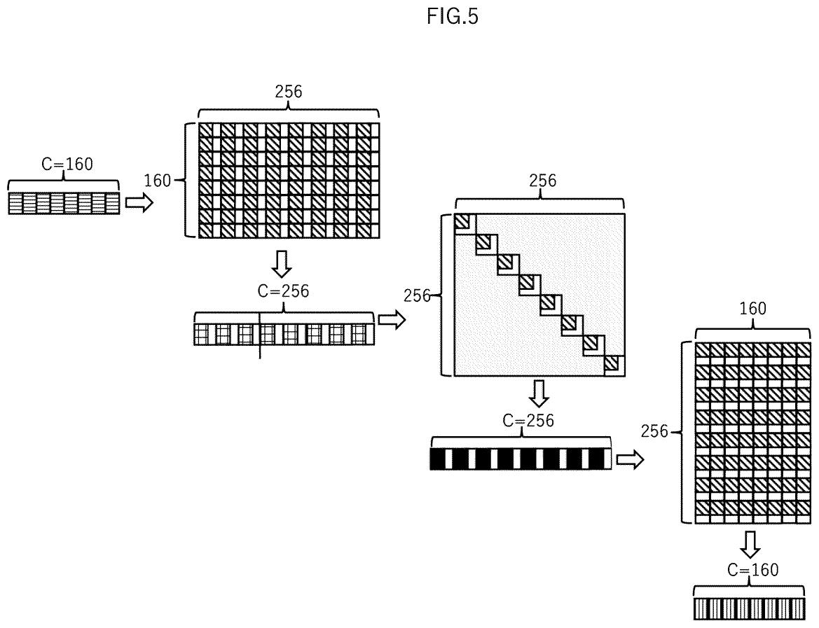

FIG. 5 is an explanatory diagram illustrating another example where grouped convolution and convolutions before and after the grouped convolution are executed as a set. Each weight shown in FIG. 5 has been modified by the pre-convolution weight modification unit 130, the grouped convolution weight modification unit 140, and the post-convolution weight modification unit 150 of this example embodiment.

For example, as shown in FIG. 5, first, convolution using a weight of 160 rows and 256 columns is executed on data with C=160, represented by horizontal stripes. The pre-convolution weight modification unit 130 generates the weight of 160 rows and 256 columns by inserting 12 (=32−20) columns of zeros to the right of the i×20 (=160/8) th column, for each i from 1 to 8, of the weight of 160 rows and 160 columns shown in FIG. 3.

By executing convolution using the weight of 160 rows and 256 columns, the grid-patterned data with C=256 in the 32-aligned state, as shown in FIG. 5, is output. The memory address indicated by the straight line in the grid-patterned data with C=256, shown in FIG. 5, is 3*32=96. That is, the starting address of each unit of the grid-patterned data is a multiple of 16.

Next, as shown in FIG. 5, grouped convolution is executed on the grid-patterned data with C=256. In the example shown in FIG. 5, grouped convolution is executed on each group of 32 channels, and a weight of 32 rows and 32 columns are used for each convolution.

The grouped convolution weight modification unit 140 generates the weight of 32 rows and 32 columns by inserting 12 (=32−20) columns of zeros at the right end of the weight of 20 (=160/8) rows and 20 (=160/8) columns, as shown in FIG. 3, and by inserting 12 (=32−20) rows of zeros at the bottom of the weight of 20 rows and 20 columns. The grouped convolution weight modification unit 140 executes the above row and column insertion processes on each of the 8 weights of 20 rows and 20 columns shown in FIG. 3.

By executing convolution using the weight of 32 rows and 32 columns, the black data with C=256 in the 32-aligned state, as shown in FIG. 5, is output.

Next, as shown in FIG. 5, convolution using a weight of 256 rows and 160 columns is executed on black data with C=256. The post-convolution weight modification unit 150 generates the weight of 256 rows and 160 columns by inserting 12 (=32−20) rows of zeros below the ix×0 (=160/8) th row, for each i from 1 to 8, of the weight of 160 rows and 160 columns, as shown in FIG. 3.

By executing convolution using the weight of 256 rows and 160 columns, vertical striped data with C=160, shown in FIG. 5, is output. The vertical striped data with C=160, shown in FIG. 5, is the same as the vertical striped data with C=160 shown in FIG. 3.

The pre-convolution weight modification unit 130, the grouped convolution weight modification unit 140, and the post-convolution weight modification unit 150 store the optimized CNN model, including the modified weights, in the post-change CNN model storage unit 300.

In this example embodiment, when the grouped convolution weight modification unit 140 inserts zero rows into each weight, the pre-convolution weight modification unit 130 inserts zero columns into the weights. Also, when the grouped convolution weight modification unit 140 inserts zero columns into the weights, the post-convolution weight modification unit 150 inserts zero rows into the weights.

### Explanation of Operation

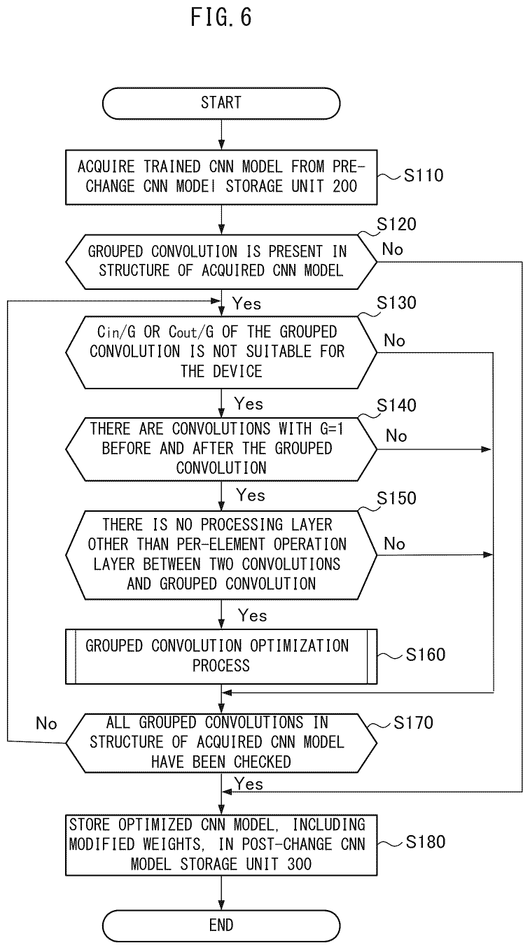

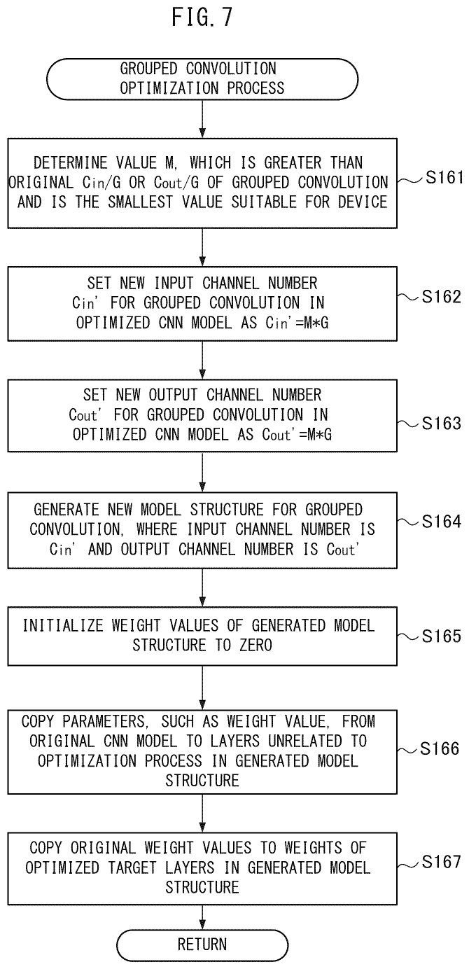

Hereinafter, an operation of the grouped convolution processing optimization device 100 in this example embodiment will be described with reference to FIG. 6 and FIG. 7. FIG. 6 is a flowchart illustrating an optimization process executed by the grouped convolution processing optimization device 100 according to this disclosure.

First, the optimization candidate structure detection unit 110 of the grouped convolution processing optimization device 100 acquires a trained CNN model from the pre-change CNN model storage unit 200 (step S110).

Next, the optimization candidate structure detection unit 110 evaluates whether a grouped convolution is present in the structure of the acquired CNN model (step S120). When there is no grouped convolution (No in step S120), the grouped convolution processing optimization device 100 terminates the optimization process.

When a grouped convolution is present (Yes in step S120), the optimization candidate structure detection unit 110 evaluates whether Cᵢₙ/G or Cₒᵤₜ/G of the grouped convolution is a suitable value for a device (step S130).

In this example, the device refers to the AI chip 400. A suitable value for the device is, for example, “32” in the case of the 32-aligned state shown in FIG. 5. When Cᵢₙ/G and Cₒᵤₜ/G of the grouped convolution are suitable values for the device (No in step S130), the process moves to step S170.

When Cᵢₙ/G or Cₒᵤₜ/G of the grouped convolution is not suitable for the device (Yes in step S130), the optimization candidate structure detection unit 110 evaluates whether there are convolutions with G=1 before and after the grouped convolution (step S140). When there is no convolution with G=1 before and after the grouped convolution (No in step S140), the process moves to step S170.

When there are convolutions with G=1 before and after the grouped convolution (Yes in step S140), the optimization candidate structure detection unit 110 evaluates whether there is a processing layer other than a per-element operation layer between the two convolutions and the grouped convolution (step S150). When there is a processing layer other than a per-element operation layer between the two convolutions and the grouped convolution (No in step S150), the process moves to step S170.

When there is no processing layer other than a per-element operation layer between the two convolutions and the grouped convolution (Yes in step S150), the grouped convolution processing optimization device 100 executes a grouped convolution optimization process (step S160).

Next, the optimization candidate structure detection unit 110 evaluates whether all grouped convolutions in the structure of the acquired CNN model have been checked (step S170). When there are still unchecked grouped convolutions (No in step S170), the optimization candidate structure detection unit 110 repeats the process from step S130.

When all grouped convolutions in the structure of the acquired CNN model have been checked (Yes in step S170), the pre-convolution weight modification unit 130, the grouped convolution weight modification unit 140, and the post-convolution weight modification unit 150 store the optimized CNN model, including the modified weights, in the post-change CNN model storage unit 300 (step S180). After storing, the grouped convolution processing optimization device 100 terminates the optimization process.

Next, the grouped convolution optimization process in step S160, which is a sub-process that constitutes the optimization process shown in FIG. 6, will be explained with reference to FIG. 7. FIG. 7 is a flowchart illustrating an operation of a grouped convolution optimization process executed by the grouped convolution processing optimization device 100 according to this disclosure.

First, the optimal channel number determination unit 120 determines the value M, which is greater than an original Cᵢₙ/G or Cₒᵤₜ/G of the grouped convolution and is the smallest value suitable for the device (step S161).

Next, the optimal channel number determination unit 120 sets the new input channel number Cᵢₙ′ for the grouped convolution in the optimized CNN model as Cᵢₙ′=M*G (step S162).

Next, the optimal channel number determination unit 120 sets the new output channel number Cₒᵤₜ′ for the grouped convolution in the optimized CNN model as Cₒᵤₜ′=M*G (step S163).

It should be noted that the optimal channel number determination unit 120 may execute at least one of the processes in step S162 or step S163.

Next, the pre-convolution weight modification unit 130, the grouped convolution weight modification unit 140, and the post-convolution weight modification unit 150 generate a new model structure for the grouped convolution, where the input channel number is Cᵢₙ′ and the output channel number is Cₒᵤₜ′ (step S164).

Next, the pre-convolution weight modification unit 130, the grouped convolution weight modification unit 140, and the post-convolution weight modification unit 150 initialize the weight values of the generated model structure to zero (step S165).

Next, the pre-convolution weight modification unit 130, the grouped convolution weight modification unit 140, and the post-convolution weight modification unit 150 copy parameters, such as weight values, from the original CNN model to the layers unrelated to the optimization process in the generated model structure (step S166).

Next, the pre-convolution weight modification unit 130, the grouped convolution weight modification unit 140, and the post-convolution weight modification unit 150 copy the original weight values to the weights of the optimized target layers in the generated model structure (step S167).

Particularly, the grouped convolution weight modification unit 140 copies the original weight values for each weight matrix. As described above, the pre-convolution weight modification unit 130, the grouped convolution weight modification unit 140, and the post-convolution weight modification unit 150 realize the insertion process shown in FIG. 5 by copying the original weight values to the weights of the new model structure.

After copying the weight values, the grouped convolution processing optimization device 100 returns to the optimization process shown in FIG. 6.

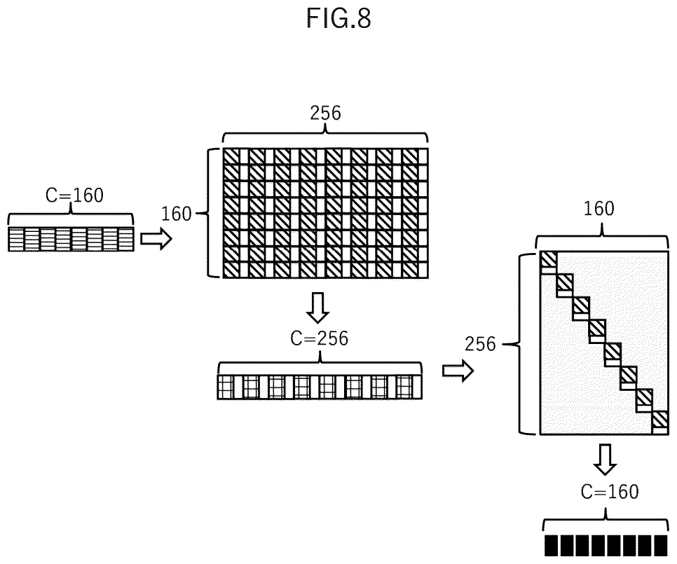

In this example embodiment, the grouped convolution processing optimization device 100 may modify only one of the weights used in the convolutions before and after the grouped convolution. FIG. 8 is an explanatory diagram illustrating an example where the grouped convolution and the convolution before the grouped convolution are executed as a set.

In the example shown in FIG. 8, the convolution after the grouped convolution is omitted. The example in FIG. 8 shows a case where the optimal channel number determination unit 120 has determined that only the input channel number Cᵢₙ affects performance and thus needs to meet the constraints, while the output channel number Cₒᵤₜ does not affect performance and does not need to meet the constraints.

In this case, as shown in FIG. 8, the pre-convolution weight modification unit 130 modifies the weights in the same manner as in the example shown in FIG. 5. On the other hand, the post-convolution weight modification unit 150 does not modify the weights.

Furthermore, the grouped convolution weight modification unit 140 generates a weight of 32 rows and 20 columns by inserting 12 (=32−20) rows of zeros at the bottom of the weight of 20rows and 20 columns shown in FIG. 3. The grouped convolution weight modification unit 140 executes the above zero row insertion process for each of the eight weights of 20 rows and 20 columns shown in FIG. 3.

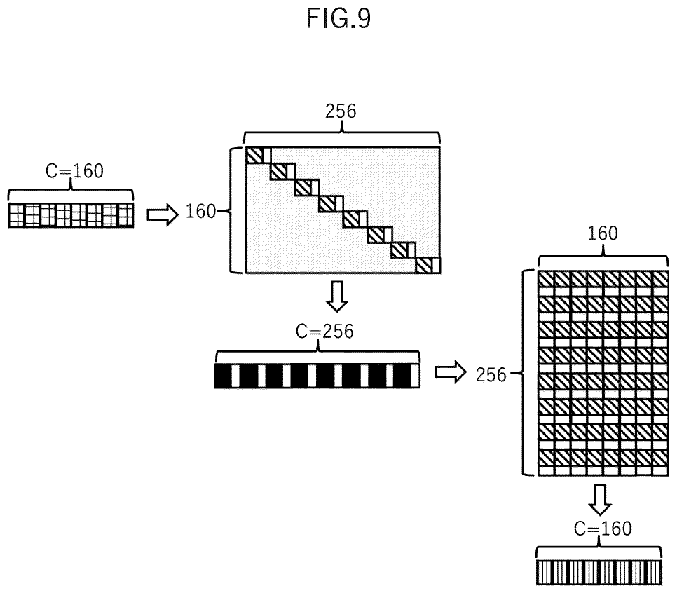

FIG. 9 is an explanatory diagram illustrating an example where a grouped convolution and a convolution after the grouped convolution are executed as a set. In the example shown in FIG. 9, the convolution before the grouped convolution is omitted. The example in FIG. 9 shows a case where the optimal channel number determination unit 120 has determined that only the output channel number Cₒᵤₜ affects performance and thus needs to meet the constraints, while the input channel number Cᵢₙ does not affect performance and does not need to meet the constraints.

In this case, as shown in FIG. 9, the post-convolution weight modification unit 150 modifies the weights in the same manner as in the example shown in FIG. 5. On the other hand, the pre-convolution weight modification unit 130 does not modify the weights.

Further, the grouped convolution weight modification unit 140 generates a weight of 20rows and 32 columns by inserting 12 (=32−20) columns of zeros at the right end of the weight of 20 rows and 20 columns shown in FIG. 3. The grouped convolution weight modification unit 140 executes the above zero column insertion process for each of the eight weights of 20 rows and 20 columns shown in FIG. 3.

As described above, the grouped convolution weight modification unit 140 of this example embodiment, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using an i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined, executes at least one of a column insertion process that inserts (M−N/G) columns of zeros at the right end of the i-th weight matrix for each i from 1 to G or a row insertion process that inserts (M−N/G) rows of zeros at the bottom of the i-th weight matrix for each i from 1 to G.

Further, the pre-convolution weight modification unit 130 of this example embodiment executes an input weight matrix insertion process that inserts (M−N/G) columns of zeros to the right of the i×N/G-th column of the input weight matrix for each i from 1 to G. Additionally, the post-convolution weight modification unit 150 executes an output weight matrix insertion process that inserts (M−N/G) rows of zeros below the i×N/G-th row of the output weight matrix for each i from 1 to G.

The grouped convolution processing optimization device 100 of this example embodiment executes at least one of the input weight matrix insertion process or the output weight matrix insertion process. Also, the pre-convolution weight modification unit 130 executes the input weight matrix insertion process when the row insertion process is executed. The post-convolution weight modification unit 150 executes the output weight matrix insertion process when the column insertion process is executed.

Moreover, in this example embodiment, M is the smallest multiple (for example 32) that is greater than a predetermined number (for example 16) N/G. In the grouped convolution, a matrix in which the i-th weight matrices are arranged diagonally from the top-left to the bottom-right in the order of i=1 to G may also be used as the weight matrix.

Additionally, in this example embodiment, the optimal channel number determination unit 120 determines at least one of an input channel number, which is the number of channels in the input data for the grouped convolution subject to constraints, or an output channel number, which is the number of channels in the output data resulting from the grouped convolution, to be M*G.

The grouped convolution weight modification unit 140 executes the row insertion process when the input channel number is determined to be M*G, and executes the column insertion process when the output channel number is determined to be M*G.

Furthermore, in this example embodiment, the optimization candidate structure detection unit 110 evaluates whether the input convolution, the grouped convolution, and the output convolution are each defined in the trained convolutional neural network.

### Description of Effects

Some AI chips experience slower execution speeds for grouped convolutions due to constraints imposed on memory addressing. The pre-convolution weight modification unit 130, the grouped convolution weight modification unit 140, and the post-convolution weight modification unit 150 of the grouped convolution processing optimization device 100 in this example embodiment adjust the weight matrices used in the convolutional layers that make up the CNN model.

By adjusting the weight matrices, the grouped convolution processing optimization device 100 converts processes executed by the CNN model into processes suitable for AI chips with such constraints. Although the amount of computation increases when the process is converted for the AI chip, the grouped convolution can be executed faster because it is replaced with a process the AI chip excels at. In other words, the grouped convolution processing optimization device 100 enables the grouped convolution process to be accelerated on AI chips with constraints without changing the processing results.

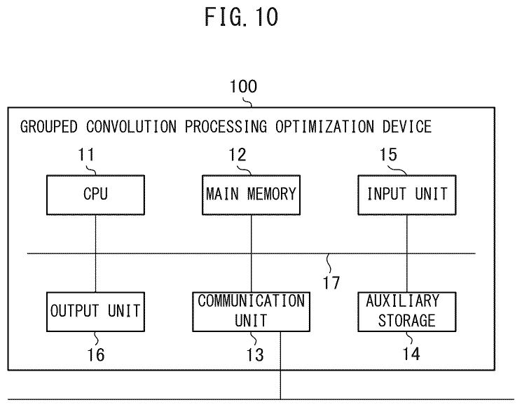

Hereinafter, a specific example of a hardware configuration of the grouped convolution processing optimization device 100 in this example embodiment will be described. FIG. 10 is an explanatory diagram illustrating a hardware configuration example of the grouped convolution processing optimization device 100 according to this disclosure.

The grouped convolution processing optimization device 100 shown in FIG. 10 includes a CPU 11, a main memory 12, a communication unit 13, and an auxiliary storage 14. It also includes an input unit 15, which allows the user to interact with the system, and an output unit 16, which presents processing results or progress to the user.

The grouped convolution processing optimization device 100 is realized in software by the CPU 11 executing a program that provides the functionality of the various components.

That is, the CPU 11 loads the program stored in the auxiliary storage 14 into the main memory 12 and executes it to control the operations of the grouped convolution processing optimization device 100, thereby realizing the functions through software.

Note that the grouped convolution processing optimization device 100 shown in FIG. 10 may include a DSP (Digital Signal Processor) instead of the CPU 11, or it may include both a CPU and a DSP.

The main memory 12 is used as a working area or a temporary storage area for data. The main memory 12 may be, for example, RAM (Random Access Memory).

The communication unit 13 has a function of inputting and outputting data with peripheral devices via a wireless network (information communication network).

The auxiliary storage 14 is a non-volatile tangible storage medium. Examples of non-volatile tangible storage media include magnetic disks, magneto-optical disks, CD-ROM (Compact Disk Read-Only Memory), DVD-ROM (Digital Versatile Disk Read-Only Memory), and semiconductor memory.

The input unit 15 has a function of inputting data and processing instructions. The input unit 15 may be an input device such as a keyboard, a mouse, or a touch panel.

The output unit 16 has a function of outputting data. The output unit 16 may be a display device such as an LCD display, a touch panel, or a printing device such as a printer.

As shown in FIG. 10, the components of the grouped convolution processing optimization device 100 are connected via a system bus 17.

In the grouped convolution processing optimization device 100, the auxiliary storage 14 stores programs to implement the optimization candidate structure detection unit 110, the optimal channel number determination unit 120, the pre-convolution weight modification unit 130, the grouped convolution weight modification unit 140, and the post-convolution weight modification unit 150.

Additionally, the grouped convolution processing optimization device 100 may be implemented with circuits, such as LSI (Large Scale Integration) hardware components, that realize the functions shown in FIG. 1.

Alternatively, the grouped convolution processing optimization device 100 may be implemented in hardware without using a CPU or similar elements. For example, some or all of the components may be realized using general-purpose circuits, dedicated circuits, processors, or a combination of these. These may be configured on a single chip (for example, the above-mentioned LSI) or on multiple chips connected via a bus. Some or all of the components may be realized by a combination of the above-mentioned circuits and a program.

Additionally, some or all of the components of the grouped convolution processing optimization device 100 may be configured with one or more information processing devices equipped with an arithmetic unit and a memory unit.

When some or all of the components are realized by multiple information processing devices or circuits, the information processing devices or circuits may be centrally or distributed. For example, the information processing devices or circuits may be realized in the form of a client-server system or a cloud computing system, each connected via a communication network.

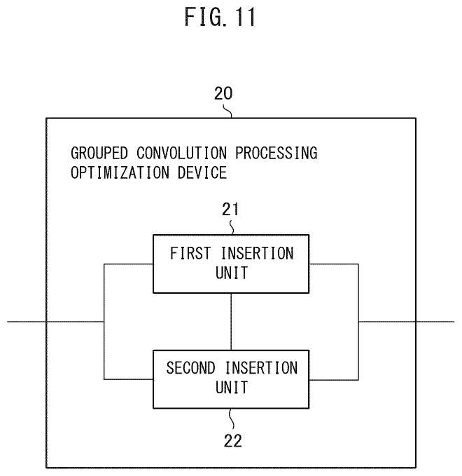

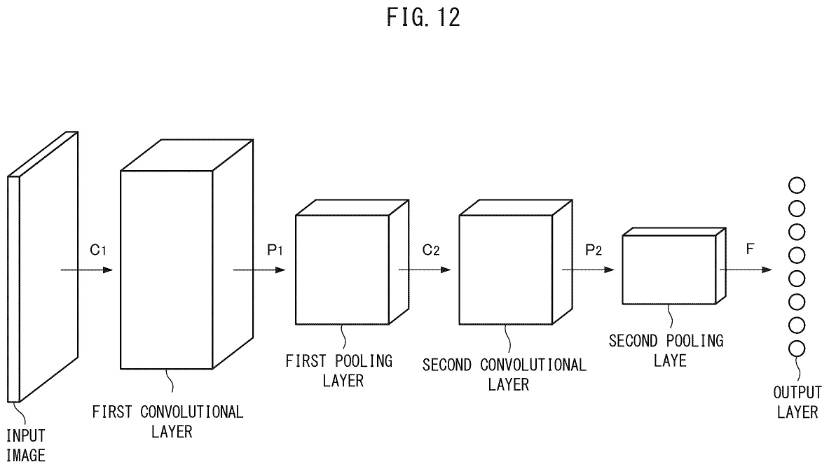

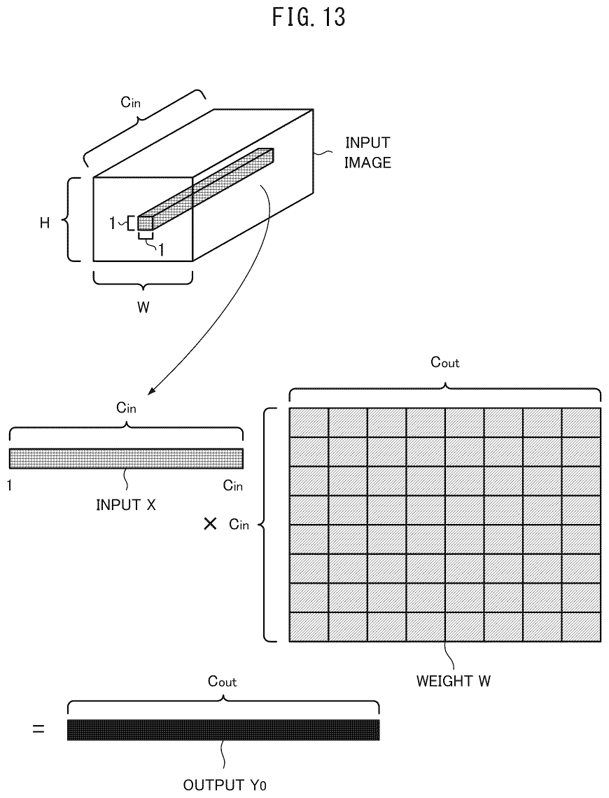

Next, the outline of this disclosure will be described. FIG. 11 is a block diagram illustrating an overview of a grouped convolution processing optimization device according to this disclosure. The grouped convolution processing optimization device 20 according to the present disclosure includes a first insertion unit 21 (for example, the grouped convolution weight modification unit 140) that executes at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined, and a second insertion unit 22 (for example, the pre-convolution weight modification unit 130 and the post-convolution weight modification unit 150) that executes at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G, wherein the second insertion unit executes the input weight matrix insertion process when the row insertion process is executed, and executes the output weight matrix insertion process when the column insertion process is executed.

When such a grouped convolution processing optimization device is used, a hardware circuit with memory addressing constraints can execute grouped convolution at a higher speed.

Additionally, M may be the smallest multiple that is greater than the predetermined number N/G.

In grouped convolution, a matrix where i-th weight matrices are arranged diagonally from the top-left to the bottom-right in the order of i=1 to G may be used as the weight matrix.

This configuration allows the grouped convolution processing optimization device to reduce the impact of overhead involved in executing grouped convolution.

Additionally, the grouped convolution processing optimization device 20 includes a determination unit (for example, the optimal channel number determination unit 120) that determines at least one of an input channel number, which is the number of channels in input data for the grouped convolution subject to constraints, or an output channel number, which is the number of channels in the output data resulting from the grouped convolution, to be M*G. The first insertion unit 21 executes the row insertion process when the input channel number is determined to be M*G, and executes the column insertion process when the output channel number is determined to be M*G.

This configuration allows the grouped convolution processing optimization device to adjust the weights that are the target of modification.

Additionally, the grouped convolution processing optimization device 20 includes an evaluation unit (for example, the optimization candidate structure detection unit 110) that evaluates whether the input convolution, the grouped convolution, and the output convolution are each defined in the trained convolutional neural network.

This configuration allows the grouped convolution processing optimization device to determine whether or not to modify the weights used in each convolution.

Also, some or all of the above example embodiments may be described as in the following supplementary notes, but are not limited to these examples.

(Supplementary note 1) A grouped convolution processing optimization device includes: a first insertion unit that executes at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined; and a second insertion unit that executes at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G, wherein the second insertion unit executes the input weight matrix insertion process when the row insertion process is executed, and executes the output weight matrix insertion process when the column insertion process is executed.

(Supplementary note 2) The grouped convolution processing optimization device according to Supplementary note 1, wherein M is the smallest multiple that is greater than a predetermined number N/G.

(Supplementary note 3) The grouped convolution processing optimization device according to Supplementary note 1 or supplementary note 2, wherein in the grouped convolution, a matrix in which the i-th weight matrices are arranged diagonally from the top-left to the bottom-right in the order of i=1 to G is used as the weight matrix.

(Supplementary note 4) The grouped convolution processing optimization device according to any one of Supplementary notes 1 to 3, further including a determination unit that determines at least one of an input channel number, which is the number of channels in input data for the grouped convolution subject to constraints, or an output channel number, which is the number of channels in the output data resulting from the grouped convolution, to be M*G, wherein the first insertion unit executes the row insertion process when the input channel number is determined to be M*G, and executes the column insertion process when the output channel number is determined to be M*G.

(Supplementary note 5) The grouped convolution processing optimization device according to any one of Supplementary notes 1 to 4, further including an evaluation unit that evaluates whether the input convolution, the grouped convolution, and the output convolution are each defined in the trained convolutional neural network.

(Supplementary note 6) A grouped convolution processing optimization method includes: executing at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined; and executing at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G, wherein the input weight matrix insertion process is executed when the row insertion process is executed, and the output weight matrix insertion process is executed, when the column insertion process is executed.

(Supplementary note 7) The grouped convolution processing optimization method according to Supplementary note 6, wherein M is the smallest multiple that is greater than a predetermined number N/G.

(Supplementary note 8) The grouped convolution processing optimization method according to Supplementary note 6 or 7, wherein in the grouped convolution, a matrix in which the i-th weight matrices are arranged diagonally from the top-left to the bottom-right in the order of i=1 to G is used as the weight matrix.

(Supplementary note 9) The grouped convolution processing optimization method according to any one of Supplementary notes 6 to 8, further includes determining at least one of an input channel number, which is the number of channels in input data for the grouped convolution subject to constraints, or an output channel number, which is the number of channels in the output data resulting from the grouped convolution, to be M*G, wherein the row insertion process is executed when the input channel number is determined to be M*G, and the column insertion process is executed when the output channel number is determined to be M*G.

(Supplementary note 10) The grouped convolution processing optimization method according to any one of Supplementary notes 6 to 9, further includes evaluating whether the input convolution, the grouped convolution, and the output convolution are each defined in the trained convolutional neural network.

(Supplementary note 11) A grouped convolution processing optimization program that causes a computer to execute: a first insertion process that executes at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined; and a second insertion process that executes at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G, wherein the second insertion process causes the input weight matrix insertion process to be executed when the row insertion process is executed, and causes the output weight matrix insertion process to be executed when the column insertion process is executed.

(Supplementary note 12) The grouped convolution processing optimization program according to Supplementary note 11, wherein M is the smallest multiple that is greater than a predetermined number N/G.

(Supplementary note 13) The grouped convolution processing optimization program according to Supplementary note 11 or 12, wherein in the grouped convolution, a matrix in which the i-th weight matrices are arranged diagonally from the top-left to the bottom-right in the order of i=1 to G is used as the weight matrix.

(Supplementary note 14) The grouped convolution processing optimization program according to any one of Supplementary notes 11 to 13, wherein the program causes the computer to further execute a determination process that determines at least one of an input channel number, which is the number of channels in input data for the grouped convolution subject to constraints, or an output channel number, which is the number of channels in the output data resulting from the grouped convolution, to be M*G, wherein the first insertion process causes the row insertion process to be executed when the input channel number is determined to be M*G, and causes the column insertion process to be executed when the output channel number is determined to be M*G.

(Supplementary note 15) The grouped convolution processing optimization program according to any one of Supplementary notes 11 to 14, wherein the program causes the computer to further execute an evaluation process that evaluates whether the input convolution, the grouped convolution, and the output convolution are each defined in the trained convolutional neural network.

The example embodiments have been described with reference to specific examples, but the present disclosure is not limited to these example embodiments. Various changes and modifications may be made within the scope of the present disclosure as understood by those skilled in the art. Moreover, each example embodiment can be combined with other example embodiments as appropriate.

1. A grouped convolution processing optimization device comprising:
a memory storing software instructions; and
one or more processors configured to execute the software instructions to:
execute at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined; and
execute at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G,
wherein the one or more processors execute the input weight matrix insertion process when the row insertion process is executed, and execute the output weight matrix insertion process when the column insertion process is executed.

2. The grouped convolution processing optimization device according to claim 1, wherein M is the smallest multiple that is greater than a predetermined number N/G.

3. The grouped convolution processing optimization device according to claim 1, wherein
in the grouped convolution, a matrix in which the i-th weight matrices are arranged diagonally from the top-left to the bottom-right in the order of i=1 to G is used as the weight matrix.

4. The grouped convolution processing optimization device according to claim 1, wherein the one or more processors are further configured to execute the software instructions to
determine at least one of an input channel number, which is the number of channels in input data for the grouped convolution subject to constraints, or an output channel number, which is the number of channels in the output data resulting from the grouped convolution, to be M*G,
wherein the one or more processors execute the row insertion process when the input channel number is determined to be M*G, and execute the column insertion process when the output channel number is determined to be M*G.

5. The grouped convolution processing optimization device according to claim 1, wherein the one or more processors are further configured to execute the software instructions to
evaluate whether the input convolution, the grouped convolution, and the output convolution are each defined in the trained convolutional neural network.

6. A grouped convolution processing optimization method performed by a computer and comprising:
executing at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined; and
executing at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G,
wherein the input weight matrix insertion process is executed when the row insertion process is executed, and the output weight matrix insertion process is executed, when the column insertion process is executed.

7. The grouped convolution processing optimization method according to claim 6, wherein
M is the smallest multiple that is greater than a predetermined number N/G.

8. The grouped convolution processing optimization method according to claim 6, wherein in the grouped convolution, a matrix in which the i-th weight matrices are arranged diagonally from the top-left to the bottom-right in the order of i=1 to G is used as the weight matrix.

9. The grouped convolution processing optimization method according to claim 6, further comprising:
determining at least one of an input channel number, which is the number of channels in input data for the grouped convolution subject to constraints, or an output channel number, which is the number of channels in the output data resulting from the grouped convolution, to be M*G,
wherein the row insertion process is executed when the input channel number is determined to be M*G, and the column insertion process is executed when the output channel number is determined to be M*G.

10. The grouped convolution processing optimization method according to claim 6, further comprising:
evaluating whether the input convolution, the grouped convolution, and the output convolution are each defined in the trained convolutional neural network.

11. A non-transitory computer-readable storage medium storing a grouped convolution processing optimization program causes a computer to execute processes comprising:
executing at least one of a column insertion process that inserts (M−N/G) columns of zeros at the right end of an i-th weight matrix for each i from 1 to G or a row insertion process that inserts (M−N/G) rows of zeros at the bottom of the i-th weight matrix for each i from 1 to G, when a constraint that requires convolution computation to be executed on data composed of M channels (where M is an integer greater than N/G) for a grouped convolution is imposed on a trained convolutional neural network, in which an input convolution that executes convolutional computation using an input weight matrix of N rows and N columns on data composed of channels arranged sequentially from the first channel to the N-th channel (where N is an integer of 2 or more), the grouped convolution that divides the result of the input convolution into G parts (where G is an integer of 2 or more) along the channel direction, and executes convolutional computation for each i from 1 to G using the i-th weight matrix of N/G rows and N/G columns on the divided data composed of channels from {(i−1)×N/G+1} to (i×N/G), and an output convolution that executes convolutional computation using an output weight matrix of N rows and N columns on the result of the grouped convolution are each defined; and
executing at least one of an input weight matrix insertion process that inserts (M−N/G) columns of zeros to the right of the i×N/G-th column of the input weight matrix for each i from 1 to G or an output weight matrix insertion process that inserts (M−N/G) rows of zeros below the i×N/G-th row of the output weight matrix for each i from 1 to G,
wherein the input weight matrix insertion process is executed when the row insertion process is executed, and the output weight matrix insertion process is executed when the column insertion process is executed.

12. The non-transitory computer-readable storage medium according to claim 11, wherein M is the smallest multiple that is greater than a predetermined number N/G.

13. The non-transitory computer-readable storage medium according to claim 11, wherein in the grouped convolution, a matrix in which the i-th weight matrices are arranged diagonally from the top-left to the bottom-right in the order of i=1 to G is used as the weight matrix.

14. The non-transitory computer-readable storage medium according to claim 11, wherein
the grouped convolution processing optimization program causes the computer to further execute processes comprising:
determining at least one of an input channel number, which is the number of channels in input data for the grouped convolution subject to constraints, or an output channel number, which is the number of channels in the output data resulting from the grouped convolution, to be M*G,
wherein the row insertion process is executed when the input channel number is determined to be M*G, and the column insertion process is executed when the output channel number is determined to be M*G.

15. The non-transitory computer-readable storage medium according to claim 11, wherein
the grouped convolution processing optimization program causes the computer to further execute processes comprising:
evaluating whether the input convolution, the grouped convolution, and the output convolution are each defined in the trained convolutional neural network.
